(19) United States
(12) Patent Application Publication
(10) Pub. No.: US 2007/0035439 A1
(43) Pub. Date: Feb. 15, 2007

(54) Radar installation

(75) Inventor: Marc C. Michel, Auckland (NZ)

Correspondence Address: MARSHALL, GERSTEIN & BORUN LLP, 233 S. WACKER DRIVE, SUITE 6300, SEARS TOWER, CHICAGO, IL, 60606, US

(73) Assignee: NAVMAN NZ LIMITED, Auckland (NZ)

(21) Appl. No.: 10/549,406

(22) PCT Filed: Mar. 9, 2004
(86) PCT No.: PCT/NZ04/00050

§ 371 Date: Oct. 23, 2006

(30) Foreign Application Priority Data
Mar. 14, 2003 (NZ) 524757

(51) Int. Cl. G01S 13/93; G01S 7/04

(52) U.S. Cl. 342/41; 342/179; 342/197; 342/52; 342/57; 342/58; 342/73; 342/82; 342/89

(57) ABSTRACT

In a radar processing of the radar video, and preferably most video inserts such as maps or charts, are carried out at the head end of the radar and the video output conveyed to at least one monitor over a standard digital channel. Remote control of the radar and video processing functions may be carried out over the same channel.

### TECHNICAL FIELD

This invention relates a radar head containing the radar transmitter and receiver and to a method controlling the same and of producing the processed output therefrom.

### BACKGROUND

Typically a radar consists of at least two parts, a radar transmitter and receiver, which may be combined with an antenna, and a radar signal treatment device which may be combined with the radar display and which may include a facility for adding other signals such as a GPS map or a north heading compass repeater.

### PRIOR ART

It is known to locate the radar transmitter and receiver remotely from the display unit, and in some cases the separation may be many kilometers (typically in air traffic control or in military systems). In such cases it is normal to provide raw radar information to the remote units and to rely on them to do their own processing. This raw radar may be provided in digital format.

The digital format may be Ethernet or similar, as shown in U.S. Pat. Nos. 6,249,241 and 5,592,170.

### THE PROBLEM

The problem with this is that it requires the transmission of fairly high bandwidth information to the receivers often at low signal levels. In a shipboard situation it is normal for this bandwidth to be catered for by using a relatively fragile coaxial cable, and to run control cables to the radar receiver and transmitter to control such things as pulse repetition frequency (prf), gain and decluttering. Such long cable runs tend to introduce electrical noise and are mechanically fragile.

Additionally where multiple displays are required to carry out their own radar signal processing the expense of providing the required processing in each display is not inconsiderable.

### OBJECT

It is an object of the invention to provide a radar in which the majority of the processing takes place in the head unit and the feed to any displays is by serial or other digital medium, preferably by wireless digital medium or to at least provide the public with a useful choice.

### STATEMENT OF INVENTION

In one aspect the invention consists of a radar head containing a radar transmitter and receiver and closely associated with a radar antenna wherein the head also includes a processing unit for processing the received radar signals and for combining these with video from other sources, which processing unit can output video data in more than one digital format for use by at least one digitally driven display unit.

Preferably the processing unit can simultaneously output video data for at least two differing processed radar signals.

Preferably the processing unit can output at least a raw radar video signal and a processed radar signal.

Preferably the processing unit can simultaneously output radar video signals for differing radar ranges.

Preferably the processing unit is controllable by digital input signals.

Preferably the processing unit can receive control signals for the radar receiver and transmitter.

Preferably the processing unit can receive digital signal inputs which can be added to the video output during processing.

Preferably the processing unit may output signals representative additional video feeds.

Preferably a north heading signal is combined with the radar signal to allow synchrony with other video feeds.

Preferably all signal processing is carried out digitally.

Preferably the output feed may be utilised by more than a single display unit.

Preferably the radar transmitter is controllable by digital signals from the processing unit.

Preferably the digital signals are to a standard specification.

Preferably the digital signals are USB, Firewire, Bluetooth or Ethernet.

Preferably the digital signals are distributed wirelessly.

The invention also consists in a method of producing a radar signal for a remote display consisting in receiving at least one video signal from a radar head, receiving at least a video signal from a map or chart overlay, receiving a signal capable of orienting the radar signal against the map signal, and producing a digital video output consisting of at least two video signals wherein the signals may be displayed on at least one video display separately or combined.

Preferably the digital video output includes a raw radar output, a processed radar output, a GPS map output and at least one heading signal.

Preferably the heading signal is a north heading signal.

### DRAWINGS DESCRIPTION

These and other aspects of this invention, which would be considered as novel in all aspects would become apparent from the following description, which is given by way of example only, with reference to the accompanying drawings in which:

FIG. 1 shows a block diagram of the inventive radar system

FIG. 2 shows a block diagram of a digital display unit.

FIG. 3 shows a block diagram of the video processing unit

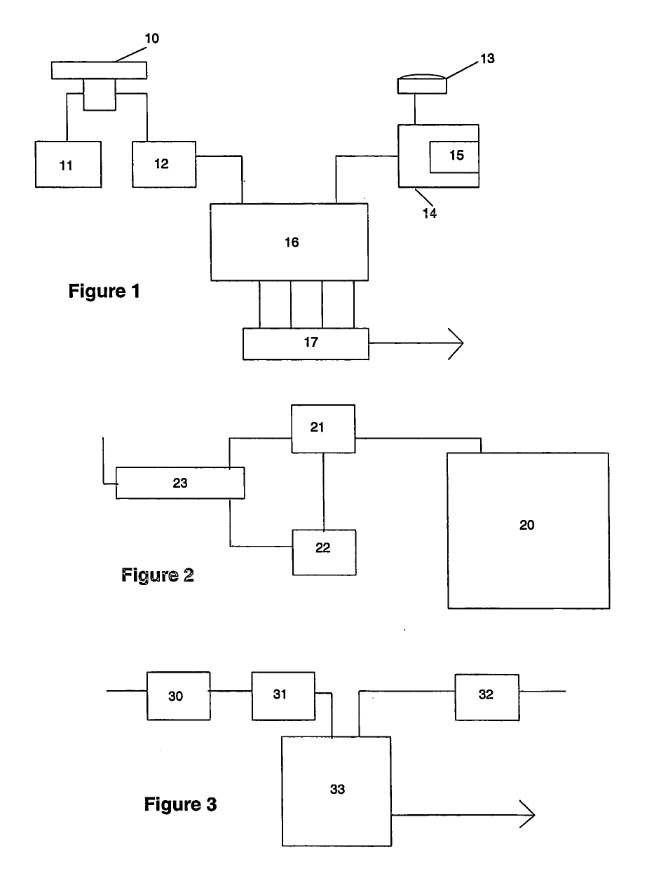

FIG. 1 shows a radar antenna 10 which is fed from a transmitter 11 and feeds a receiver 12. Output from the receiver is supplied to video processor 16 which also receives input from GPS receiver 14 fed from antenna 13. The GPS may also contain an electronic map or chart 15. Not shown are also other inputs for, for example, range rings and vehicle heading line. Inputs such as these may be remotely located from the video processor and may link to it as multiplexed inputs in the same manner as the control inputs do. The GPS output, for instance may actually be mutiplexed into the processor via a standard bus. A typical method of doing this is to form sequential packets of an output Ethernet signal from portions of each different video feed, with appropriate packet signatures, and reassemble the required video feeds at a packet receiver.

The video processor feeds signals to, and is fed by, multiplexer 17, the multiplexer output being encoded in a standard digital signal protocol, for instance ARINC, USB or Ethernet over cable, optical cable or wireless. It may be noted that in a shipboard environment a wireless digital protocol can only be relied upon where no bulkhead doors intervene, but that this often will provide a satisfactory service, for instance for passenger information, or where the signal is used in the bridge and can be transmitted directly from the radar head to the bridge via windows.

All of the required information is assembled in the video processor, but it may be assembled into multiple differing video streams, which may be either separately transmitted or transmitted in a multiplexed form. The video processor may for instance produce feeds for a raw signal, a decluttered signal, a moving target signal, a range ring signal, and a map signal and all may be separately encoded into the output. It is well within the capabilities of, for instance, Ethernet, to carry many simultaneous video streams at the resolution required for a radar display.

Typically the video processor is a dedicated chip designed to handle the various streams and encode them into a whole but it may consist of a series of separated chips each contributing its function.

To provide heading synchronism between the video feeds a north heading may be imposed on the radar signal in a known manner. This north heading is typically created from a flux gate compass linked to a gyro for stability, and provides a signal when the radar sweep passes through north, normally true north rather than magnetic north. The existence of a north marker in the radar signal allows easy synchronism of the radar with the map, especially at slow vessel speeds where the vessel heading continually swings.

FIG. 2 shows a block diagram of a video display unit which consists of a standard monitor 20 fed by video driver 21 from multiplexer 23. The display unit may itself combine separate video feeds for some of the displayable items. This particularly applies to range rings, where users tend to be extremely idiosyncratic in their preferences and forcing multiple displays to show the same range rings at the same video level may cause user dissatisfaction. Thus the separate video feeds can be either chosen separately or they can be combined in a manner chosen by the user if the user has this facility. The multiplexer also receives input from radar control unit 22 which allows remote control of such things as radar gain, display range, etc. Where the digital output of video processor 16 contains more than one video feed there may be local control of which is shown, or the balance between those which are shown.

Typically the streams of data are separated from a single series of data packets into the bytes making up the constituent signals. These may then be chosen, decoded as selected by the user and applied to the display.

The controls may be knob and button or they may be roller ball and button or they may be presented on a touch sensitive screen.

Since the radar video is distributed digitally there may be many displays on the same feed. Not all displays may have access to the remote radar control functions, which may be available to privileged users only on input of a password or set up to respond to a user at only one IP address.

FIG. 3 shows the video processor block diagram where the video output from the radar receiver is processed at 30 for decluttering, addition of range rings, a north heading signal, etc and then passed to vector to raster mapping processor 31 and fed into memory map 33.

In similar manner the map input from GPS 32 is also fed into the memory map at the required scale. While the GPS is shown as directly connected to the video processor it may actually be remotely located and may feed the video processor via the same digital bus which carries the output signals.

The memory map is intended to cover a raster display screen at the maximum required resolution. Output from the radar receiver, synchronised with the antenna movement, is vector mapped into the memory at the radar prf rate. Output from the GPS unit map is also mapped into the memory, preferably at a lower rate. Signals may meet one of the standard protocols, for instance NMEA.

Other video items may be written into memory, for instance information relating to the vehicle heading and speed.

The video processor may be remotely controlled for the brilliance mix between map and radar returns or other items making up the video, and it may translate remote commands into control for the radar receiver and transmitter, for instance of gain, prf or output power.

Output from the memory array is multiplexed onto an output stream in a known manner, and various parts of the output stream may be differently coloured, either to indicate their function or the signal strength or type.

### Variations

While the video processing is described as using a bitmapped memory mapped image transfer the image may be stored as a vector image and passed to the displays in this format.

The image transfer process may transfer only those portions of the image screen which have changed to give reduced bandwidth requirements. Since the entire screen may be refreshed at the radar rotation rate this will determine the bandwidth requirements.

The radar may produce outputs for multiple different ranges. This typically requires different pulse repetition frequencies and different pulse lengths, but it is possible to interleave long and short pulses at the same prf and separately select the video for the differing pulse lengths to provide a better resolution for the short ranges and an adequate signal response at the longer ranges. Cancellation or reduction of fixed returns may be separately controlled for each range display.

### INDUSTRIAL APPLICABILITY

The invention relates to a method of remotely displaying radar signals and to the system providing the remote signals, wherein the signals are transmitted over a standard digital protocol and a selection among the different signals may be made. The industrial applicability includes advantages lying in the enhanced security available from standard protocols and hardware, and the ability to choose the required video signal.

1. A radar system comprising:
a head containing a radar transmitter and a radar receiver and configured to be closely associated with a radar antenna; and
a signal processing unit included with said head for processing the received radar signals and for combining the received radar signals with data from other sources, and configured to simultaneously output data in multiple output data feeds for use by at least one display unit.

2. A radar system as claimed in claim 1, wherein the signal processing unit simultaneously outputs data for at least two differing processed radar signals.

3. A radar system as claimed in claim 1, wherein the output data feeds include a raw radar signal and a processed radar signal.

4. A radar system as claimed in claim 1, wherein the signal processing unit simultaneously outputs radar signals for differing radar ranges.

5. A radar system as claimed in claim 1, wherein the signal processing unit is controllable by digital input signals.

6. A radar system as claimed in claim 1, wherein the signal processing unit receives control signals for the radar receiver and the radar transmitter.

7. A radar system as claimed in claim 1, wherein the signal processing unit receives digital signal inputs which are added to the output data feeds during processing.

8. A radar system as claimed in claim 1, wherein a north heading signal is combined with the received radar signals to allow synchrony with other data feeds.

9. A radar system as claimed in claim 1, wherein the signal processing unit outputs signals representative of additional data feeds.

10. A radar system as claimed in claim 1, wherein all signal processing is carried out digitally.

11. A radar system as claimed in claim 1, wherein the radar transmitter is controllable by digital signals from the signal processing unit.

12. A radar system as claimed in claim 1, wherein the output data feeds are to a standard specification.

13. A radar system as claimed in claim 1, wherein the output data feeds are encoded in USB, Firewire, Bluetooth or Ethernet protocol.

14. (canceled)

15. A radar system as claimed in claim 1, wherein the output data feeds are distributed wirelessly.

16. A digital radar system as claimed in claim 1, in combination with a digital display unit which facilitates selection of one or more of the output data feeds from those provided by the radar system.

17. A radar system as claimed in claim 1, in combination with a digital display unit wherein the digital display unit has inputs allowing remote control of the radar transmitter, the receiver or the signal processing unit.

18-20. (canceled)
